(19) United States
(12) Patent Application Publication
(10) Pub. No.: US 2007/0128443 A1
(43) Pub. Date: Jun. 7, 2007

(54) Method for altering the shape of a tube

(76) Inventor: Steven C. Hoggan, Smithfield, UT (US)

Correspondence Address: Thompson E. Fehr;Suite 300, Goldenwest Corporate Center, 5025 Adams Avenue, Ogden, UT, 84403, US

(21) Appl. No.: 11/249,556

(22) Filed: Oct. 13, 2005

(51) Int. Cl. B21D 9/04; B29C 53/00

(52) U.S. Cl. 428/411.1; 264/239; 264/280; 72/369

(57) ABSTRACT

A method for altering the shape of a tube having two alternatives. In the first alternative optionally a tube is heated and then placed in a mold having a nonlinear portion of an inner surface so that gravity causes the tube to bend over the inner surface; a pressurized liquid is then introduced into the heated tube in order to expand the tube and cause it to assume the shape of the inner surface of the mold. Either with or without the bending, the mold is optionally cooled. In the second alternative the mold is maintained within a desired temperature range for heating the tube; and when such mold has a nonlinear cavity for holding a tube, closing of the mold will bend the tube. For a more pronounced bend, the tube is mechanically bent before being placed in the mold.

### BACKGROUND OF THE INVENTION

1. Field of the Invention

This invention relates to a method for altering the shape of a tube through the use of heat and a pressurized fluid.

2. Description of the Related Art

U.S. Pat. No. 6,032,501 explains, in lines 26 through 31 of column 1, “Preforming is a method of bending an elongated tube through the use of external die members to roughly relate a tube to a cavity in a die. Hydroforming, on the other hand, is a method of expanding an elongated tube to closely correspond to a cavity in a die through the use of internal hydraulic pressure.”

Both U.S. Pat. No. 5,987,950 and U.S. Pat. No. 6,032,501 first employ preforming and then hyroforming in order to vary the shape of a tube. U.S. Pat. No. 5,987,950 indicates that its technology applies to metal tubes. The chemical composition of the tube is not explicitly stated in U.S. Pat. No. 6,032,501. That patent does, however, only discuss use in the automotive industry; and a number of the cited publication are journals dealing with metal. Nowhere does U.S. Pat. No. 6,032,501 state that its technology is to be utilized with other than metal tubes.

United States patent publication no. 2005/0044913 deals with a method for progressively hydroforming a tube. In paragraph 0023 the publication states, “The method includes the step of providing a tubular member 69. The tubular member 69 is made of a metal material.”

Neither the two patents nor the publication discusses heating or cooling.

Both U.S. Pat. No. 6,272,894 and U.S. Pat. No. 6,613,164 adjust the shape of a metal tube utilizing heat to make the tube amenable to shaping by the introduction of a pressurized gas.

U.S. Pat. No. 6,272,894 explains in lines 6 through 15 of column 2, “The molding tool, having been pre-heated to a relatively high temperature for a predetermined length of time, heats the portion of the metal part residing within the internal molding cavity. A gas under pressure is then injected into the tubular metal part which causes the portion of the part residing within the internal molding cavity to expand and conform to the contour of the internal molding cavity. The molding tool is then allowed to cool before separating the first and second portions thereof and removing the metal part.”

Although not so explicitly stated, the method employed in U.S. Pat. No. 6,613,164 also appears to involve periodic heating. Lines 54 through 58 in column 3 provide, “The shells and die members are constructed so that the tubular blank being formed into the shape of the shell or cavity can be heated inductively along its length to control the heat of the tubular blank before and during the forming process. Lines 62 through 64 of column 4 indicate, “The heating is done while the tubular blank is forced into the cavity to create the desired shape,” while lines 21 through 23 in column 5 state, “ . . . the induction heating can be before and/or during the gas forming operation.”

The description in U.S. Pat. No. 6,613,164 continues in lines 59 through 67 of column 5, “In accordance with another aspect of the invention, the tubular blank is resistance heated by passing an alternating current, or direct current, through the sheet metal of the blank preparatory to moving the hollow or tubular blank into the forming shell. Induction preheating is also used. Consequently, the total tubular blank is at an elevated temperature so that the induction heating of the blank merely raises the temperature beyond the preheated temperature of the blank.”

Then in line 1 through line 10 of column 6 the following is stated: “In accordance with another aspect of the present invention, the induction heating is varied along the length of the tubular blank or over the locations of the flat hollow blanks whereby different locations are inductively heated to different temperatures, at different time intervals, to achieve optimal strain distribution control. Indeed, axial portions of the workpiece are inductively heated in different induction heating cycles dictated by the desired metallurgical characteristics and deformation amount at axial portions of the tubular blank.” And lines 24 through 28 of column 6 further explain, “The heating cycle of selected portions is controlled by varying the frequency, the power, the distance of the conductors from the workpiece, the spacing between axially adjacent conductors and the induction heating cycle time.”

Finally, a summary including the cycling of heating is given in lines 54 through 55 of column 17: “By using a precise quenching cycle with a specific heating cycle during the processing of the workpiece D, the metallurgical properties of the finished product are controlled.”

U.S. Pat. No. 6,613,164 indicates that three separate stations are utilized to perform the tubular blank, to expand and shape the blank with pressurized gas, and to quench the blank. Lines 51 through 53 of column 10 explains that the “ . . . performing operation may involve bending the tubular blank axially into a preselected general contour or profile . . . .”

And, although lines 17 through 19 in column 14 state, “In practice the conductors for the induction heating of the workpiece are non-magnetic, high resistivity steel (Inconel) tubes with water cooling,” it appears that such cooling is directed to the conductors alone, rather than to the overall mold.

And a further patent for consideration is U.S. Pat. No. 6,749,255. The process of this patent is described in line 62 of column 2 through line 10 of column 3: “Blow molding is a recently developed process in which a generally tubular shaped hollow piece of plastic is used as a blank. The plastic blank heated [sic] until it is softened to be elastic or ductile, but not to the point that it collapses. The heated plastic blank is then inserted into a mold cavity. Usually a multi-piece mold is used and the emold elements are closed over the blank. . . . A pressurized gas, such as compressed air, is then fed into the blank. The pressurized gas forces the plastic outward and into conformance with the shape of the mold cavity. The pressure is maintained while the plastic cools to assure that the shape of the mold cavity is retained by the plastic. After cooling, the mold is opened and the plastic component is removed.”

None of the preceding patents, though, cool the mold or continuously maintain the mold in a heated state. And none of such patents utilize a mold to bend a heated tube.

In the past it has also been known to utilize a jig in order to bend a baluster intended for use in a stair rail, but a mold has not been employed for this purpose.

### BRIEF SUMMARY OF THE INVENTION

The present Method for Altering the Shape of a Tube introduces a pressurized fluid to expand and shape a heated tube just as do the prior art patents with gas (and, in hydroforming, with a liquid introduced inside a tube that has not been heated).

Two alternative techniques are, though, employed in the present method that distinguish such method from the prior art.

In the first process, the tube is heated, using any technique that is known in the art, and then placed in a mold where the longitudinal axis of the heated tube conforms to the vertical shape of the mold. (Thus, if a bend is desired in the longitudinal axis of the tube, the bottom portion of the mold contains a nonlinear portion ant the portion adjacent to the place on the tube where the bend is desired.) This process is preferably utilized with plastic tubes. And the mold is preferably cooled to keep its temperature within a range that will not impede the tube, when subjected to fluid pressure, from reaching the interior surface of the mold.

In the second process, the tube is bent or preformed outside the mold, utilizing any technique that is known in the art. The mold is maintained within any elevated temperature range known in the art to be sufficient to permit a fluid to expand and shape the tube within the mold. This is in distinction to U.S. Pat. No. 6,749,255, which states that the plastic tube is retained in the mold while the plastic cools to assure that the newly formed shape is retained by the tube. Similarly, U.S. Pat. No. 6,272,895 indicates that the mold is allowed to cool before the metal tube is removed. And U.S. Pat. No. 6,613,164 cycles the heat applied to the mold with time.

This second process is preferably utilized with metal tubes.

### BRIEF DESCRIPTION OF THE SEVERAL VIEWS OF THE DRAWING

FIG. 1 illustrates a tube with its longitudinal axis bent by a nonlinear portion of a mold.

### DETAILED DESCRIPTION OF THE INVENTION

As mentioned above, the Method for Altering the Shape of a Tube of the present invention includes two alternative techniques.

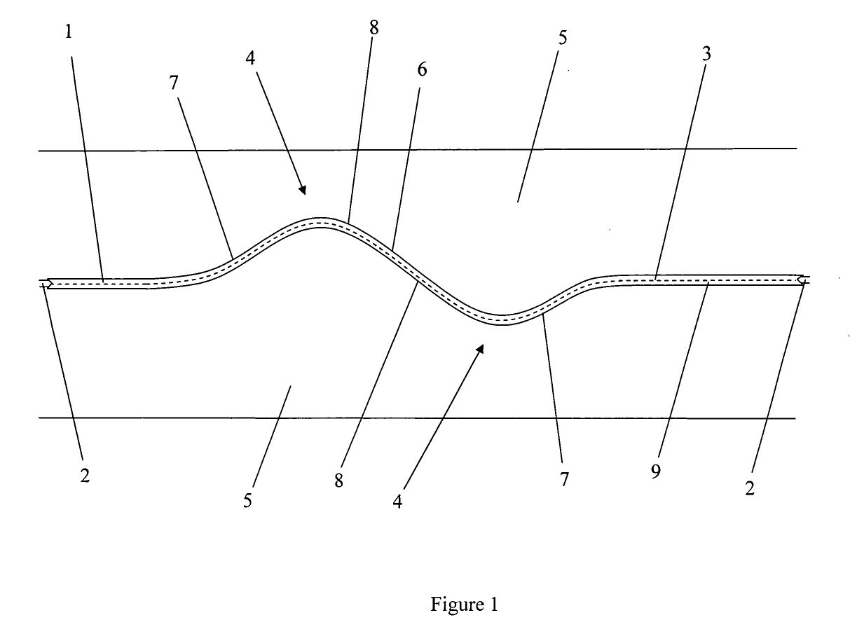

The first alternative comprises, first, heating a tube 1, using any technique that is known in the art, at least (a) to such an extent that introducing a pressurized fluid into a tube that has been sealed except for the injector or injectors that supply the fluid in any way known in the art will cause such heated tube to expand and optionally (b) to such an extent that gravity will cause the longitudinal axis 3 of the tube to bend when the tube is placed on a nonlinear inside portion 4 of a mold 5; second, placing at least a portion 6 of the heated tube 1 into a mold 5, optionally a mold having a nonlinear portion 4 of its inner surface 7, as shown in FIG. 1; third, closing the mold; fourth, introducing a pressurized fluid into the tube 1 with the tube being sealed, except for the injector 2 or injectors 2 that supply the fluid, to expand the tube 1, preferably until its outer surface 8 touches the inner surface 7 of the mold 5; and, fifth, maintaining the mold 5 closed during the introduction of the pressurized fluid, using any technique that is known in the art.

As a further option for the first alternative, the mold 5 is cooled. Such cooling commences at least when the heated tube 1 is placed in the mold 5. Preferably, this cooling continues until the introduction of the pressurized fluid is complete and, most preferably, until the tube 1 is removed from the mold 5.

Preferably the first alternative is used on plastic tubes 1, even though the tube 1 can be composed of metal. Although the tubes can be of any plastic, they are preferably polyvinyl chloride (pvc) or polyethylene. The pressurized fluid can be either a liquid or a gas. A preferred liquid is glycol; preferred gases are air, nitrogen, and carbon dioxide, with air being the most preferred.

When aluminum is used as the metal of the tube 1, the temperature to which the metal tube 1 is heated is preferably 1000 degrees Farenheit. The pressure of pressurized gas when the tube 1 is composed of aluminum is preferably in the range of 500 to 1200 pounds per square inch (psi); when the tube is composed of plastic, the pressure range of the pressurized gas is preferably 100 to 250 psi.

Cooling of the mold 5 is preferably accomplished by running a liquid through the mold 5 or a structure which holds the mold 5, such as a mold base in a device used for keeping the mold closed (such as a press), using any method that is known in the art for circulating a liquid through a solid object (such as channels). The liquid is preferably antifreeze and is, after passing through the mold 5 sent to a chiller, which can be any device known in the art for cooling a liquid—such as a heat sink; radiator; or, preferably, a refrigeration unit.

The mold 5, itself, holds the tube 1 unless optional mold inserts are placed in the mold 1, which, in such circumstances, is commonly termed a “base mold,” for this purpose. When mold inserts are employed, they are, though, considered part of the mold 5 for purposes of this disclosure.

Non-exclusive examples of methods for heating the mold 5 are resistive electrical wiring, inductive heating, or burning a combustible material such as natural gas.

Cooling of the mold 5 generally is done only when the tube is composed of plastic; and, in such circumstances, the temperature of the mold 5 is maintained between 50 degrees Fahrenheit and 80 degrees Fahrenheit with the most preferably temperature being 70 degrees. The inventor has found that a shaped plastic tube 1 will remain too warm to retain its shape upon removal from the mold 5 if the temperature of the mold exceeds 100 degrees Fahrenheit and that cooling of the mold 5 only at the end of the method would create and undesirable lengthening of cycle times for a series of tubes 1.

The second alternative comprises maintaining the mold 5 within a temperature range which will permit the heated tube to expand when pressurized fluid is introduced into the tube with the tube having been sealed except for the injector or injectors that supply the fluid an any way known in the art, placing at least a portion 6 of the tube 1 into the mold 5; closing the mold; introducing a pressurized fluid into the tube 1 with the tube being sealed, except for the injector 2 or injectors 2 that supply the fluid, to expand the tube 1 until its outer surface 8 touches the inner surface 7 of the mold 5; and maintaining the mold 5 closed during the introduction of the pressurized fluid, using any technique that is known in the art.

The cavity 9 for holding the tube 1 in the mold can be either linear or nonlinear. If the cavity 9 is nonlinear, closing the mold 5 will bend the tube 1. If, however, a more pronounced bend is desired when the tube 1 is composed of metal, the tube 1 is mechanically bent, using any technique that is known in the art, prior to having at least a portion of such tube being placed in the mold 5.

Although the second alternative is preferably used for metal tubes 1, most preferably tubes 1 composed of aluminum, the second alternative can be used on plastic tubes 1. And even though the tubes can be of any plastic, they are preferably polyvinyl chloride (pvc) or polyethylene. The pressurized fluid can be either a liquid or a gas. A preferred liquid is glycol; preferred gases are air, nitrogen, and carbon dioxide, with air being the most preferred.

When aluminum is used as the metal of the tube 1, the temperature to which the metal tube 1 is heated is preferably 1000 degrees Farenheit. The pressure of pressurized gas when the tube 1 is composed of aluminum is preferably in the range of 500 to 1200 pounds per square inch (psi); when the tube is composed of plastic, the pressure range of the pressurized gas is preferably 100 to 250 psi.

As with the first alternative, in the case of the second alternative the mold 5, itself, holds the tube 1 unless optional mold inserts are placed in the mold 1 for this purpose. When inserts are employed, they are considered part of the mold 5 for purposes of this disclosure.

Also as with the first alternative, in the case of the second alternative non-exclusive examples of methods for heating the mold 5 are resistive electrical wiring, inductive heating, or burning a combustible material such as natural gas.

The mold 5, itself, holds the tube 1 unless optional mold inserts are placed in the mold 1 for this purpose. When mold inserts are employed, they are considered part of the mold 5 for purposes of this disclosure.

Non-exclusive examples of methods for heating the mold 5 are resistive electrical wiring, inductive heating, or burning a combustible material such as natural gas.

The present inventor has determined that all the various processes described above can be utilized to make, among other things, a baluster (also termed a “spindle”) and a newel post, which are vertical columns utilized to support stair railings.

As used herein the term “preferable” or “preferably” means that a specified element or technique is more acceptable than another but not that such specified element or technique is a necessity.

I claim:

1. A method for altering the shape of a tube, which comprises:
heating a tube having a longitudinal axis to such an extent that introducing a pressurized fluid into the tube after it has been sealed except for the injector or injectors that introduce a pressurized fluid into the tube will cause the heated tube to expand and to such an extent that gravity will cause the longitudinal axis of the tube to bend when the tube is placed on a nonlinear inside portion of a mold;
placing at least a portion of the heated tube into a mold having an inside surface and a nonlinear portion of such inside surface;
closing the mold;
introducing a pressurized fluid into the tube with the tube being sealed except for the injector or injectors that supply the fluid, to expand the tube; and
maintaining the mold closed during the introduction of the pressurized fluid.

2. The method for altering the shape of a tube as recited in claim 1, further comprising:
cooling the mold commencing at least when the heated tube is placed in the mold and continuing at least until the introduction of the pressurized fluid is complete.

3. The method for altering the shape of a tube as recited in claim 1, further comprising:
cooling the mold commencing at least when the heated tube is placed in the mold and continuing at least until the tube is removed from the mold.

4. A method for altering the shape of a tube, which comprises:
heating a tube having a longitudinal axis to such an extent that introducing a pressurized fluid into the tube after it has been sealed except for the injector or injectors that introduce a pressurized fluid into the tube will cause the heated tube to expand;
placing at least a portion of the heated tube into a mold having a nonlinear inside portion;
closing the mold;
introducing a pressurized fluid into the tube with the tube being sealed except for an injector or injectors that supply the fluid, to expand the tube;
maintaining the mold closed during the introduction of the pressurized fluid; and
cooling the mold commencing at least when the heated tube is placed in the mold and continuing at least until the introduction of the pressurized fluid is complete.

5. A method for altering the shape of a tube, which comprises:
heating a tube having a longitudinal axis to such an extent that introducing a pressurized fluid into the tube after it has been sealed except for the injector or injectors that introduce a pressurized fluid into the tube will cause the heated tube to expand;
placing at least a portion of the heated tube into a mold having a nonlinear inside portion;
closing the mold;
introducing a pressurized fluid into the tube with the tube being sealed except for an injector or injectors that supply the fluid, to expand the tube;
maintaining the mold closed during the introduction of the pressurized fluid; and
cooling the mold commencing at least when the heated tube is placed in the mold and continuing at least until the tube is removed from the mold.

6. A method for altering the shape of a tube, which comprises:
maintaining a mold with a temperature range which will permit a tube inserted into the mold to expand when pressurized fluid is introduced into the tube when the tube has been sealed except for an injector or injectors that supply the fluid;
placing at least a portion of a tube into the mold;
closing the mold;
introducing a pressurized fluid into the tube when the tube has been sealed, except for a injector or injectors that supply the fluid, to expand the tube; and
maintaining the mold closed during the introduction of the pressurized fluid.

7. The method for altering the shape of a tube as recited in claim 6, further comprising:
assuring that the mold has a nonlinear cavity for holding the tube.

8. The method for altering the shape of a tube as recited in claim 7, further comprising:
before placing at least a portion of a tube into the mold, mechanically bending the tube.

9. The method for altering the shape of a tube as recited in claim 6, further comprising:
before placing at least a portion of a tube into the mold, mechanically bending the tube.

10. A plastic baluster, wherein:
said plastic baluster is formed from a plastic tube, the shape of which plastic tube has been altered by a method selected from the group consisting of the method of claim 1, the method of claim 2, the method of claim 3, the method of claim 4, the method of claim 5, the method of claim 6, the method of claim 7, the method of claim 8, or the method of claim 9.

11. A metal baluster, wherein:
said metal baluster is formed from a metal tube, the shape of which metal tube has been altered by a method selected from the group consisting of the method of claim 1, the method of claim 2, the method of claim 3, the method of claim 4, the method of claim 5, the method of claim 6, the method of claim 7, the method of claim 8, or the method of claim 9.

12. A plastic newel post, wherein:
said plastic newel post is formed from a plastic tube, the shape of which plastic tube has been altered by a method selected from the group consisting of the method of claim 1, the method of claim 2, the method of claim 3, the method of claim 4, the method of claim 5, the method of claim 6, the method of claim 7, the method of claim 8, or the method of claim 9.

13. A metal newel post, wherein:
said metal newel post is formed from a metal tube, the shape of which metal tube has been altered by a method selected from the group consisting of the method of claim 1, the method of claim 2, the method of claim 3, the method of claim 4, the method of claim 5, the method of claim 6, the method of claim 7, the method of claim 8, or the method of claim 9.
